SEQUENCE LISTING (10 sequences)

SEQ ID NO: 1 - DNA, 343 bp, artificial sequence
  Primer
cagaattcggatccgcatgcatnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnntaagcttctcgagagatctga

SEQ ID NO: 2 - DNA, 328 bp, artificial sequence
  primer
aatacagcatgcatnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnnntaattaacctcagg

SEQ ID NO: 3 - DNA, 103 bp, artificial sequence
  primer
cagaattcggatccgcatgcatnnnnnnnnnnnnnnnnnnnnnnnnnnnnnnnnnnnnnnnnnnnnnnnnnnnnnnnnnnnntaagcttctcgagagatctga

SEQ ID NO: 4 - DNA, 115 bp, artificial sequence
  primer
aatacagcatgcatnnnnnnnnnnnnnnnnnnnnnnnnnnnnnnnnnnnnnnnnnnnnnnnnnnnnnnnnnnnnnnnnnnnnnnnnnnnnnnnnnnnnnnntaattaacctcagg

SEQ ID NO: 5 - DNA, 14 bp, artificial sequence
  primer
cctgaggttaatta

SEQ ID NO: 6 - DNA, 18 bp, artificial sequence
  primer
tgatgtgccagattatgc

SEQ ID NO: 7 - DNA, 19 bp, artificial sequence
  primer
taatacgactcactatagg

SEQ ID NO: 8 - DNA, 18 bp, artificial sequence
  primer
gctagttattgctcagcg

SEQ ID NO: 9 - DNA, 18 bp, artificial sequence
  primer
caggaaacagctatgacc

SEQ ID NO: 10 - DNA, 18 bp, artificial sequence
  primer
tgtaaaacgacggccagt

(19) United States
(12) Patent Application Publication
(10) Pub. No.: US 2006/0068397 A1
(43) Pub. Date: Mar. 30, 2006

(54) High throughput screening method for identifying molecules having biocidal function

(76) Inventors: Xiongying Cheng, Cary, NC (US); Illimar Altosaar, Ottawa (CA)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/948,799

(22) Filed: Sep. 24, 2004

(51) Int. Cl. C40B 40/08; C40B 30/06

(52) U.S. Cl. 435/6

(57) ABSTRACT

Novel methods for screening and cloning DNA sequences coding for biocidal molecules, and for identifying biocidal molecules involving use of viability staining assay are provided. The methods consist of construction of libraries of DNA from natural and synthetic sources, and expression of cloned DNA in surrogate hosts, identification of DNA clones biocidal to the host cells by viability assay and isolation of the DNA sequences coding for biocidal molecules. Further provided are methods of identifying the biocidal molecules and their use.

### FIELD OF INVENTION

The present invention relates to a method for identifying and cloning nucleic acid sequences encoding molecules having biocidal functions and for identification of biocidal molecules.

### BACKGROUND OF THE INVENTION

Infectious diseases are the leading cause of death globally killing more than 17 million people worldwide annually, and in the United States alone cause a disease burden of more than $20 billion annually. Fungal infections (mycoses) are becoming a major concern for a number of reasons, including the limited number of antifungal agents available, the increasing incidence of species resistant to known antifungal agents, and the growing population of immunocompromised patients at risk for opportunistic fungal infections, such as organ transplant patients, cancer patients undergoing chemotherapy, burn patients, AIDS patients, or patients with diabetic ketoacidosis. The incidence of systemic fungal infections increased 600% in teaching hospitals and 220% in non-teaching hospitals during the 1980's.

Resistance of bacteria and other pathogenic microorganisms to antimicrobial agents is another problem intensified and compounded by the accelerating appearance of antibiotic-resistant bacteria, the widespread use of antibiotics in farm animals and the over-prescription of antibiotics by physicians, and the declining research into new antibiotics with different modes of action.

In agriculture, crop losses resulting from pathogenic organisms such as viruses, bacteria, fungi and nematodes are historic and widespread problems. These crop losses caused by pathogen-related plant damage result in economic losses amounting to billions of dollars annually. This problem has been addressed in the past by employing a wide variety of chemicals to reduce pest damage to plant crops. However, many chemicals are potentially toxic to man and animals and often become concentrated in, for example, lakes, ponds and other water supplies and they also add considerable cost to farmers. From farm to fork all along the food chain pathogenic microorganisms cause food poisonings and death, the economic damage thereof is estimated at $32 billion per anum.

Control and treatment of these diseases and pests require continued discovery of new molecules with biocidal activity. Currently, the biocidal compounds, such as antibacterial and antifungal agents are mainly discovered through screening of synthetic chemicals or chemical libraries. In these processes, compounds are screen either by their ability to inhibit growth of target organisms, or, as described in U.S. Pat. No. 6,303,115, by their ability to bind to target molecules which are generally essential gene products of a target organism.

Increasing evidence suggests that endogenous peptides and proteins with antimicrobial properties play an important role in host defense, to prevent or alleviate undesired interferences from other organisms. These molecules possess marked microbicidal activity and have been isolated from a variety of animals and plants. For example, andropin, a reproductive tract epithelial peptide was isolated from Drosophila; magainin from granular glands of Xenopus laevis; dermaseptin from the skin of the arboreal frog Phyllomedusa bicolor and alpha-thionin from wheat. The foothill yellow-legged frog Rana boylii produces peptides with antimicrobial activity from its skin secretions. In humans a number of defensins are thought to play a major role in the defense of small intestinal crypts against colonization by potential pathogens. In addition, these molecules can be used to develop new therapeutic compounds other than microbial agents. For example, antimicrobial peptides from skin secretions of Chinese red belly toad Bombina maxima have been demonstrated to possess a significant anti-HIV activity and have been shown to have significant antitumor activity. Isolation and characterization of these molecules thus not only provide insight into the defense mechanisms of living organisms but also clues and leads for discovery of new drugs and approaches for disease control.

A general scheme for isolation and cloning of DNA sequences coding for biocidal molecules such as antimicrobial protein or peptide, as described in U.S. Pat. No. 5,986,176, U.S. Pat. No. 6,551,631 and U.S. Pat. No. 6,521,590 involves identification of source materials, extraction and purification of proteins in multi-step biochemical procedures, functional assay of purified proteins against microbes, sequence determination of identified protein, design of degenerate nucleic acid probe, screening of nucleic acid library, and cloning of identified nucleic acid sequence. This process is tedious, costly and complex thereby limiting access to vast existing resources to exploit new classes of antimicrobial agents, particularly these existing at low abundance yet but being highly potent.

An alternative to the approach is genomics based homologous cloning. For example, cationic antimicrobial peptides are often encoded as prepropeptides, where the signal peptides (pre-portion) are highly conserved relative to the active peptide. Primers can then be designed based on these conserved sequences to amplify new members of antimicrobial genes from related species by PCR. However, this approach requires prior sequence knowledge of already-identified peptides, proteins or genes, and in most cases, results in isolation and identification of a sequence that is homologous to what has been discovered already, and is not applicable to identify novel biocidal molecules.

Over the past two decades, more than 500 antimicrobial peptides and proteins have been identified, and are classified into a handful of classes such as thionins, defensins, cecropins, drosomycin, kinins, bombinin, and magainin. However, this is likely representing only a small fraction of all biocidal peptides and proteins existing in the highly diversified organisms. Therefore, there is a need for a method to screen the vast number of potential targets at high throughput.

It is well known to those in the art, when appropriately constructed, DNA fragments can be expressed in surrogate hosts to generate functional molecules, such as peptides and proteins as they are in the endogenous species. For example, a large number of cDNA clones can be expressed in E. coli as an expression library. This allows screening a library of molecules for their biocidal activity based on their toxicity to host cells. Various methods are available to assay toxicity of cells by molecules synthesized within the cells. However, these methods often require massive cell manipulations, such as colony pickup, culture and cell growth measurement, and are therefore not applicable, or costly when used for screening large numbers of candidate molecules.

U.S. Pat. No. 6,589,738 discloses a method for identifying genes that are essential for microbial proliferation using an inducible expression vector comprising an exogenous sequence and expressing the exogenous sequence in host E. coli. The expression vector is induced within a test population of host cells, and any exogenous sequences that negatively impact growth of the test population are isolated. Assays to determine negative impact of growth include growth measurement, enzymatic assays, including determining green fluorescent protein (GFP). However, the use of GFP or similar marker systems for determining cell growth require the use of a dedicated host cell screening system.

Walker (2001, J. Peptide Res. 58: 380) teaches a method for identifying and cloning bioactive peptides that involves inducible expression and transferring (patching) individual colonies of bacteria onto induction media to select the desired clone. The process is laborious and would be difficult to be applied to large library screening without assistance of automatic instruments. For example, Walker reports screening 20,000 colonies, patching 50 colonies per plate, or using 400 plates to screen the 20,000 colonies. To effectively screen a library comprising for example 5×10⁶ colonies would require the use of 10,000 plates and days or weeks of patching.

### SUMMARY OF THE INVENTION

The present invention relates to a method for identifying and cloning nucleic acid sequences encoding molecules having biocidal functions and for identification of biocidal molecules.

It is at object of the invention to provide an improved high throughput screening method for identifying molecules having biocidal function.

The present invention relates generally to cloning methods involving use of a vital assay for identifying nucleic acid sequences coding for one or more than one molecule having a biocidal function, including antifungal, antibacterial, insecticidal, antiviral, anticancer and antitumor activities.

The present invention provides a method of identifying a nucleic acid sequence encoding a molecule having biocidal function comprising the step of:
a. constructing a library of nucleic acid molecules, isolated from an organism or part thereof, or synthesized chemically, each of the nucleic acid molecules operably linked to an inducible promoter sequence in a vector;
b. introducing the library into host cells to produce transformed cells;
c. growing the transformed cells in the absence of an inducer;
d. adding the inducer and growing the transformed cells to express each of the nucleic acid molecules in the library to produce a library of induced colonies or cells;
e. staining the induced colonies or cells with one or more than one dye;
f. determining the viability of the induced colonies or cells, and identifying colonies with reduced or lost cell viability; and
g. isolating the nucleic acid sequence from the colonies with reduced or lost cell viability.

Furthermore, in the step of growing (step c), adding (step d), staining (step e), determining (step f), or a combination thereof the transformed host cells may be grown, induced, stained and assayed on solid supports, for example, membrane filters. The membrane filters may be selected from the group consisting of cellulose, nitrocellulose, nylon, and PVDF membranes. In the step of constructing (step a) the inducible promoter may be a transcriptional regulating sequence controlled by a chemical agent, and the chemical agent may be isopropyl thiogalactoside (IPTG) or galactose.

The present invention pertains to the method described above, wherein in the step of adding (step d.) replica sets of transformed cells are obtained from the transformed cells, one replica of the replica set is grown in the absence of the inducer, and a second replica of the replica set is grown in the presence of the inducer to produce induced colonies or cells.

The present invention provides the method as described above, wherein the step of straining (step e.) the one or more than one dye is selected from the group consisting of a dye that stains a viable cell, a dye that stains a non-viable cell, and a dye that stains a cell with reduced viability. Preferably, the one or more than one dye is selected from the group consisting of trypan blue, bromothymol blue, oxonol, melanie, neutral red, methylene blue, indocyanine green, a fluorogenic vital dye, 4′,6-diamidino-2-phenylindole (DAPI), propidium iodide (PI), 7-AAD, Resazurin, a tetrazolium salt, and MTT.

The present invention provides the method as described above wherein the host cells are prokaryotic cells, or eukaryotic cells, including fungal, plant or animal cells. If the host is a bacterial cell, the bacteria may be selected from the group consisting of Acidaminococcus, Acinetobacter, Aeromonas, Alcaligenes, Bacteroides, Bordetella, Branhamella, Brucella, Calymmatobacterium, Campylobacter, Cardiobacterium, Chromobacterium, Citrobacter, Edwardsiella, Enterobacter, Escherichia, Flavobacterium, Francisella, Fusabacterium, Haemophilus, Klebsiella, Legionella, Moraxella, Morganella, Neisseria, Pasturella, Plesiomonas, Proteus, Providencia, Pseudomonas, Salmonella, Serratta, Shigella, Staphylococcus, Streptobacillus, Veillonella, Vibrio, and Yersinia. If the host is a fungal cell, the fungal cell may be selected from the group consisting of Candida, Aspergillus, Cryptococcus, Histoplasma, Coccidioides, Paracoccidioides, Blastomyces, Basidiobolus, Conidiobolus, Rhizopus, Rhizomucor, Mucor, Absidia, Mortierella, Cunninghamella, Saksenaea, Pseudallescheria, Sporotrichosis, Fusarium, Trichophyton, Trichosporon, Microsporum, Epidermophyton, Scytalidium, Malassezia, Actinomycetes, Sporothrix, Penicillium, Saccharomyces and Pneumocystis.

In accordance with one aspect of the present invention there is provided a method for direct screening of a nucleic acid library, made from a living organism, or synthetic DNA for biocidal molecules, thus enabling isolation of DNA sequences which are responsible for in vivo synthesis of the biocidal molecules. Another aspect of the present invention is the use of a colony staining method to identify DNA clones whose products a biocidal among vast majority of non-biocidal clones. Direct colony staining allows quick and high-throughput screening of biocidal clones efficiently and unambiguously.

It also permits further validations such as recombinant DNA rescue and purification of biocidal molecules from the colony. In addition, use of membrane filter for host cell growth screening allows handling and moving of a large quantity of colonies between different culture conditions, and particularly, allows the staining to be performed on large quantity of colonies simultaneously and without cross-contamination of these colonies, an important prerequisite for subsequent cloning steps.

In this method, nucleic acid fragments, used in library construction, can be isolated from various sources, from prokaryotic and eukaryotic, or synthesized chemically. The sequences are inserted into expression vectors, under control of an inducible promoter. The recombinant nucleic acid molecules are then transformed into surrogate hosts such as E. coli, or S. cerevisiae to generate library in non-induced condition. The cells hosting “toxic”, as well as “neutral” DNA sequences are proliferated in non-inductive conditions to form colonies. To identify DNA clone whose products are toxic (biocidal) to host cells the colonies are then transferred to inductive conditions to induce the expression of cloned genes. Cells hosting a DNA sequence coding for biocidal molecules will trigger the loss of cell viability leading to cell death or injury depending on the functionality and efficacy of the biocidal molecule. The impaired cells are then visualized by staining with dye or dye combination, for the sake of unambiguous and easy detection. The biocidal DNA can be routinely recovered from the identified colony by methods known in the art such as PCR.

It is anticipated that only a very small proportion of DNA sequences from a given source codes for molecules having biocidal functions in the surrogate host cells. It is therefore an objective of the invention to provide a high thorough-put format for efficient screening and identification of very rare biocidal genes.

To achieve the objective, transformed cells are grown on membrane filters to develop discrete colonies, instead of agar medium or wells of plate as usual. The colony-bearing membrane filters ate used for subsequent steps, such as colony transfer, induction, and staining. In this way, thousands of colonies can be handled on a membrane filter with a diameter of 100 mm, and can be transferred instantly from non-induction medium to induction medium, and stained by placing the filters onto solidified dye solution. The chemically inert and permeable filter allows the dye molecules to diffuse from underneath the membrane and come into contact with the colonies on it, without disturbing the colony; permitting easy isolation of cells of interest.

The biocidal activity can be further validated by culturing the cells harboring the putative biocidal genes in both induction and non-induction condition. A comparison of cell growth in the two conditions may be used to define the efficacy of biocidal activity resulting from the cloned gene. Under induced conditions, the growth of cells containing biocidal molecules is anticipate to slow down or to be completely inhibited.

Another way of testing the biocidal activity and determination of biocidal molecules can involve the isolation of the cloned DNA sequence. The sequence can be used to synthesize the corresponding protein or peptide in non-inhibitory host, or by chemical methods. The synthesized protein or peptide can be assayed for biocidal activity using standard methods, such as bacterial inhibition test.

The method of the present invention provides high efficiency screening of biocidal or bioactive genes. The advantages of the method of the present invention include 1) simplicity in the screening process; 2) versatility in the surrogate host, in that any desired host may be used without prior preparation (e.g. transformation with a marker gene, for example GFP), 3) speed of screening, and 4) low cost. Furthermore, no specific or dedicated instrumentation is required to complete the screen of the present invention, and the method of the present invention may be combined with prior art methods as required.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 shows a schematic illumination of the screening and cloning scheme described in the present invention including construction of DNA expression library in an appropriate vector, followed by proliferation of the library in host cells to form sizable colonies and induced expression of cloned genes. Host cell viability may be assayed by dye staining methods, and viability-impaired colony selected to isolate an identified biocide gene.

FIG. 2 shows staining of living and dead E. coli colonies grown on an MF membrane with various dye and dye combinations at concentration of 0.01% (w:v). The cells were killed by heating in Petri dishes floating on water bath at 90° C. for 10 min. FIG. 2(a) Living (left panel) and heat-killed (right panel) cells stained with trypan blue. FIG. 2(b). Living (left panel) and heat-killed (right panel) cells stained with oxonol. FIG. 2(c). Living (left panel) and heat-killed (right panel) cells stained with bromophenol blue+oxonol. FIG. 2(d) Living (left panel) and heat-killed (right panel) cells stained with oxonol+bromophenol+eosin Y. FIG. 2(e). Living (left panel) and heat-killed (right panel) cells stained with trypan blue+bromophenol+eosin Y.

FIG. 3 shows the formation of E. coli colonies on a membrane filter after culturing on LB agar medium for 14 hours.

FIG. 4 shows staining of colonies on the membrane filer with solidified dye solution.

FIG. 5 shows blue colored colonies among thousands of uncolored colonies after the staining with trypan blue (0.01%) for 10 min.

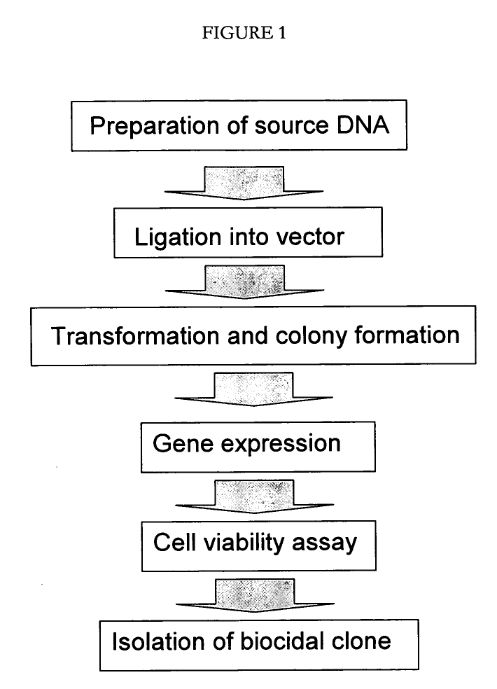

### DETAILED DESCRIPTION

The present invention relates to a method for identifying and cloning nucleic acid sequences encoding molecules having biocidal functions and for identification of biocidal molecules. This invention provides a screening and cloning procedure for identifying novel genes encoding biocidal molecules, from different sources of interest. More specifically, this invention relates to identification of nucleic acid sequences and their related molecules that are biocidal to a target organism.

The following description is of a preferred embodiment.

As used herein, biocidal molecules are defined as molecules possessing at least one of the following activities: antifungal activity, which may include anti-yeast activity, antibacterial activity, antiviral activity, anti-insect activity, anticancer and antitumor activity. Activity includes a range of antagonistic effects from partial inhibition, reduced growth rate, to killing a cell or host. Biocidal molecules include, but not limited to, nucleic acids, proteins, polypeptides, peptides, DNA transcripts such as antisense mRNA, ribozymes, inhibiting RNA molecules, enzymes, organic and inorganic compounds that are produced of accumulated as a result of expression of one or more than one cloned gene, as well as primary and secondary metabolites, for example but not limited to, alkaloids, isoprenoids and terpenes.

A non limiting example of a biocidal molecule is an antimicrobial peptide or AMP, AMPs originate from a wide range of organisms including plants, animals, many insects marine life and micro-organisms. Antimicrobial peptides are being considered as a novel and viable source of antibiotics (e.g. Zhang L. J. and Falla T. J., 2004 Exp Opin Invest Drugs. 13(2): 97-106). AMPs have shown a wide spectrum of activity against many different micro-organisms, such as antiviral, antibacterial, antiendotoxic, antibiotic potentiating and antifungal. Antimicrobial peptides function by disruption of the structure of the bacterial membrane rather than inhibition of any specific mechanism within an organism. Their general non-specific activity is due to their commonly cationic nature (net positive charge) and their hydrophobicity (amphipathic). This enables interactions with the lipid bilayer and pore formation in the membrane to ultimately cause cells lysis. This mechanism of killing is often referred to as the “carpet model” (Shai Y, 2002, Biopolymers. 66(4):236-248) and is less likely to have resistance develop against it due to its non-specific nature. Since such peptides have no specific microbial target, organisms are unable to mount any type of specific resistance against them.

Present invention teaches the use of recombinant DNA technology to synthesize a plurality of potential biocidal molecules within hosts expressing a recombinant DNA library. Any host that is adversely effected is a result of biocidal activity from an introduced gene is identified, for example, but not limited to, using a cell viability assay, or assaying for a reduced rate of growth and the recombinant DNA isolated from the identified cells.

According to the present invention, a DNA expression library is made so that proteins and other expression products may be produced in surrogate hosts, such as, but not limited to, prokaryotic cells for example E. coil, eukaryotic cells, for example insect, fungal, plant or animal cells. If the host is a bacterial cell, the bacteria may be selected from the group consisting of Acidaminococcus, Acinetobacter, Aeromonas, Alcaligenes, Bacteroides, Bordetella, Branhamella, Brucello, Calymmatobacterium, Campylobacter, Cardiobacterium, Chromobacterium, Citrobacter, Edwardsiella, Enterobacter, Escherichia, Flavobacterium, Francisella, Fusobacterium, Haemophilus, Klebsiella, Legionella, Moraxella, Morganella, Neisseria, Pasturella, Plesiomonas, Proteus, Providencia, Pseudomonas, Salmonella, Serratia, Shigella, Staphylococcus, Streptobacillus, Veillonella, Vibrio, and Yersinia. If the host is a fungal cell, the fungal cell may be selected from the group consisting of Candida, Aspergillus, Cryptococcus, Histoplasma, Coccidioides, Paracoccidioides, Blastomyces, Basidiobolus, Conidiobolus, Rhizopus, Rhizomucor, Mucor, Absidia, Mortierella, Cunninghamella, Saksenaea, Pseudallescheria, Sporotrichosis, Fusarium, Trichophyton, Trichosporon, Microsporum, Epidermophyton, Scytalidum, Malassezia, Actinomyeces, Sporothrix, Penicillium, Saccharomyces and Pneumocystis.

The library can be made with fragments of genomic DNA (gDNA) isolated from a source organism, or gDNA isolated from a part of a source organism, Alternatively, an expression library can be prepared using cDNA synthesized from mRNA isolated from any source organism or part thereof (cDNA library). The library may also be made of synthetic DNA sequences (sDNA library).

By an “organism” or a “source organism” it is meant an organism that has DNA or RNA. A source organism may include virus, bacteria, fungi, insect, plant, and animal. Source organisms of particular interest include those potentially rich in biocidal molecules, such as frogs, earthworms, insects, for example but not limited to the spined soldier bug. Certain tissues of these organisms such as the skin, salivary glands, or cells such as neutrophil, lymphocyte or epithelia may be more suitable for isolating biocidal molecules. These tissues may be readily identified and selected using the methods as described herein.

DNA fragments that potentially encode protein are operatively linked to an inducible promoter in an expression vector, such as plasmid vector, using recombinant DNA techniques known to those skilled in the art. Therefore, expression of the sequences can be controlled as required during the screening process. In addition, a translation start codon (ATG) and termination signal (e.g. TAG, TAA, or TGA) may be added to the cloning vector or synthetic DNA sequences to ensure proper initiation and termination of the translation of the inserted genes. The use of such sequences is well known to one of skill in the art.

By “operatively linked ” it is meant that the particular sequences interact either directly or indirectly to carry out an intended function, such as mediation or modulation of gene expression. The interaction of operatively linked sequences may, for example, be mediated by proteins that interact with the operatively linked sequences. A coding region of interns may also be introduced within a vector along with other sequences, typically heterologous sequences, to produce a chimeric construct.

Genomic DNA libraries can be made with genomic DNA sheared or digested to fragments having a desired size range using methods known in the art. The shearing or digestion process breaks down lengthy DNA molecules at random positions producing fragments that may or may not comprise sequences coding for native proteins. Furthermore, this process can generate novel reading frames encoding variant proteins or portions thereof, peptides, or proteins and peptides that do not naturally exist in the source organism. Libraries derived from recombinant vectors produced as a result of ligation of the DNA fragments within vector sequences may produce three categories of transcripts:
1) a transcript that is the same as, or that is a variant of, that produced in the source organism, and is a result of in-frame ligation with the vector. Such a transcript encodes a native protein or fragment thereof;
2) a transcript that is not produced within the source organism but as a result of random ligation with the vector it results in encoding a novel protein or peptide; and
3) a transcript that is non-sense, resulting from ligation with the vector in an orientation opposite to the normal orientation. Such transcripts may include antisense transcripts, or transcript that comprise one or more stop codons.

cDNA libraries can be made with mRNA extracted from a whole source organism, or part of the source organism. Typically mRNA is transcribed from a subset of functional genes in an organism, tissue, or cell. The composition of mRNA may be development-specific, or be changed as a result of exposing the source organism to bio-stimulus for example but not limited to invasion by a microbe or pathogen, including both pathogenic and non pathogenic organisms, or an environmental stimulus for example but not limited to changes in temperature, pH, moisture, exposure to pollutants or other chemical agents. For the purpose of the present invention, the preferred sources of mRNA are those eyed from cells or tissues of a source organism that are exposed to invasional microbes, such as, wild insects, intestinal tissue, epithelium, and neutrophils. mRNA can be reverse transcripted into cDNA by a number of standard methods as known in the art and as described herein, and cloned into expression vectors.

In addition, synthetic DNA can be chemically generated to construct DNA libraries. For this purpose, oligonucleotides of pre-determined lengths, for example between 10 to 200 nucleotides can be synthesized by methods known in the art. Both random sequences and pre-determined sequences can be synthesized for the library. An oligonucleotide consisting of ‘n’ randomly linked nucleotides generates a library of 4ⁿ nucleotide sequences and encodes for a library of up to 20^{n/3} peptide sequences. For example, an oligonucleotide with 30 complete random nucleotides can produce at maximum a collection of 1,152,921,504,606,846,976 oligonucleotide sequences and can produce up to 10,240,000,000 peptide sequences, offering vast numbers of peptide molecules for screening. For proper control of translation, both start codon and stop codon can be introduced within the oligonucleotide. Examples, which are not to be considered limiting, of a random oligonucleotide include:

| | |
|---|---|
| 5′-CAGAATTCGGATCCGCATGCAT-(XXX)₁₀₋₁₀₀-TAAGCTTCTCGAGAGATCTGA,, | (SEQ ID NO:1) |
| and | |
| 5′-AATACAGCATGCAT-(XXX)₁₀₋₁₀₀-TAATTAACCTCAGG-3′ | (SEQ ID NO:2) |

where X denotes an equimolar mixture of the nucleotides A, C, G, or T. However, if desired non-equimolar mixtures of the nucleotides A, T, C or G may also be used as desired. The sequences may contain a start codon (ATG) in front of a random sequence portion (for example but not limited to XXX₁₀₋₁₀₀), and a stop codon TAA) downstream from the start codon to provide termination signal. However, these sequences may also be included within the cloning vector, and omitted from the oligonucleotide. The sequence may also comprise specific upstream and downstream portions that may be used to manipulate the sequence, e.g. clone, sub-clone, amplify the sequence by PCR, when required. It is to be understood that the random sequence portion may be of any desired length, for example from about 3 to about 120 nucleotides in length, and any amount therebetween, for example 3, 6, 9, 12, 15, 18, 21, 24, 27, 30, 33, 36, 39, 42, 45, 48, 51, 54, 57, 60, 63, 66, 69, 72, 75, 78, 81, 84, 87, 90, 93, 96, 99, 102, 105, 108, 111, 114, 117, and 120. Non-limiting examples of such sequences include:

| | |
|---|---|
| 5′-CAGAATTCGGATCCGCATGCAT-(XXX)₂₀-TAAGCTTCTCGAGAGATCTGA,, | (SEQ ID NO:3) |
| or | |
| 5′-AATACAGCATGCAT-(XXX)₂₉-TAATTAACCTCAGG-3′ | (SEQ ID NO:4) |

To clone DNA sequences coding for biocidal compounds, it is preferred that the sequences are operatively linked to an inducible or regulated promoter in a vector, and that the vector is replicable in a surrogate host. By having control over the promoter, production of biocidal compounds can be regulated within the host. Regulation of expression can be achieved by use of inducible promoters, for example, those induced by chemical agents, or environmental conditions including temperature, pH, salt or light. In a non-inductive condition, the promoter is not active, allowing cells that comprise a DNA sequence encoding, or resulting in the production of, a biocidal product to proliferate.

An inducible regulatory element is one that is capable of directly or indirectly activating transcription of one or more DNA sequences or genes in response to an inducer. In the absence of an inducer the DNA sequences or genes will not be transcribed. Typically the protein factor that binds specifically to an inducible regulatory element to activate transcription may be present in an inactive form that is then directly or indirectly converted to the active form by the inducer. However, the protein factor may also be absent. The inducer can be a chemical agent such as a protein, metabolite, growth regulator, herbicide or phenolic compound or a physiological stress imposed directly by pH, heat, cold, salt, or toxic elements or indirectly through the action of a pathogen or disease agent such as a virus. A host cell containing an inducible regulatory element may be exposed to an inducer by externally applying the inducer to the cell. Examples, of potential inducible promoters include, but not limited to, the T7 transcription promoter and LacZ promoter induced by lactose or its analogue IPTG (isopropyl beta D thiogalactopyranoside), commonly used in E. coli, and the Gal1 promoter induced by galactose in yeast. However, any inducible promoter that may be regulated in a desired manner, and that would be available to one of skill in the ant may be used, for example the teracycline-inducible promoter (Gatz, C., 1997, Ann. Rev. Plant Physiol. Plant Mol. Biol. 48, 89-108, which is incorporated by reference), steroid inducible promoter (Aoyama, T. and Chua, N. H., 1997, Plant J. 2, 397-404; which is incorporated by reference) and ethanol-inducible promoter (Salter, M. G., et al, 1998, Plant Journal 16, 127-132; Caddick, M. X., et al, 1998, Nature Biotech. 16, 177-180, which are incorporated by reference). The present invention is not to be limited by the type of inducible promoter used.

Inducible promoter systems may have a residual level of activity or “leakiness” which leads to a basal level of transcription and expression of the genes under the control of the promoter. For the purpose of preset invention, there may be a situation where a non-leaking expression system is required to be able to clone otherwise “unclonable” genes either because the gene is unstable in a cloning vector, or the product encoded by the gene is extremely toxic to the host and the host fails to survive even in non-induced condition. Several systems have been developed with minimal leading, for example, but not limited to the pETcoco vectors (Novagen), where copy number per plasmid is reduced to one in non-induced condition, thus greatly reducing the leaky expression.

Once ligated into vectors, the recombinant DNA can be transformed into host cells by the methods as known in the art. Transformation of eukaryotic and prokaryotic cells may be performed according to standard techniques (see, e.g., Morrison, J. Bact. 132:349-351, 1977; Clark-Curtiss & Curtiss, Methods in Enzymology 101:347-362, Wu et al., eds., 1983). For example commonly used methods include but are not limited to chemical transformation, electroporation (for example, see U.S. Pat. No. 6,051,409; U.S. Pat. No. 4,684,611; U.S. Pat. No. 5,231,019; U.S. Pat. No. 5,453,367; U.S. Pat. No. 5,508,194) as would be known to one of skill in the arts.

The transformed cells may be cultured in liquid or solid media under non-induced conditions with an appropriate selective agent as commonly used within the art, for example antibiotic resistance, to proliferate (in liquid medium) and generate cell colonies, each representing a specific DNA insert. After colony formation, a cloned gene may be expressed by contacting the cells with an appropriate inducer, or exposing the cells to a change in their environmental conditions specific for the appropriate promoter, for example but not limited to a change in the temperate pH, photoperiod, salt concentration, to activate the promoter so that transcripts (e.g. RNA), translated products (e.g. peptides, proteins) or metabolites are produced in the host cells. If the induction results in synthesis of molecules that are biocidal to the host cells, the host cells will exhibit altered growth rates, for example arising from partial cell injury or be killed, depending on the biocidal activity of the synthesized molecules. Detection of host cells (colonies) with impaired biological viability after the induction of cloned genes results in identification of the biocidal genes.

The method of the present invention can identify biocidal molecules of many different action types regardless of the mode of action of the biocidal molecules. Examples included below indicate that these molecules range from a potential cell membrane disruption protein (thaumatin like protein), to enzymes that catalyze production of toxic molecules (for example oxalate oxidase) and others to antisense transcripts that knockout essential genes in host cell. The biocidal molecules that are identified may be grouped into two categories by their models of action. One category acts directly on biological target(s) in host cells, leading to loss or reduction of cell viability. Molecules from this category may be directly used as biocidal agents in various ways. The second category acts through biological target(s) to disable the cell function. Identification of molecules in this category would lead to discovery of biological targets in the cells that can be used as screening targets for other inhibitory compounds. For example, an antisense RNA sequence may result in the knockout of a viability-related host gene (essential gene), subsequently leading to the identification of the essential genes. Proteins or peptides synthesized in the library may also bind to or interact with important known or unknown cell targets, leading to inhibition of the functionality of the targets, and consequently cell viability loss. It has been shown in the literature that expression of fusion peptides that bind to E. coli DnaN, LpxA, RpoD, ProRS, SecA, GyrA. and Era each dramatically inhibited cell growth demonstrating the essentiality of these proteins to E. coli. It is anticipated that the biocidal activity detected by the method of the invention may partially result from inactivation of an essential host gene or its product.

Many methods are available to measure the viability of the cells, ranging from simple dot assay, to reporter gene based assays. However, these methods are either not capable of processing large number of cell colonies, are costly to use, or are limited to the specific surrogate host for example, that is capable of expressing the reporter gene used for the screening process (e.g., U.S. Pat. No. 6,589,739).

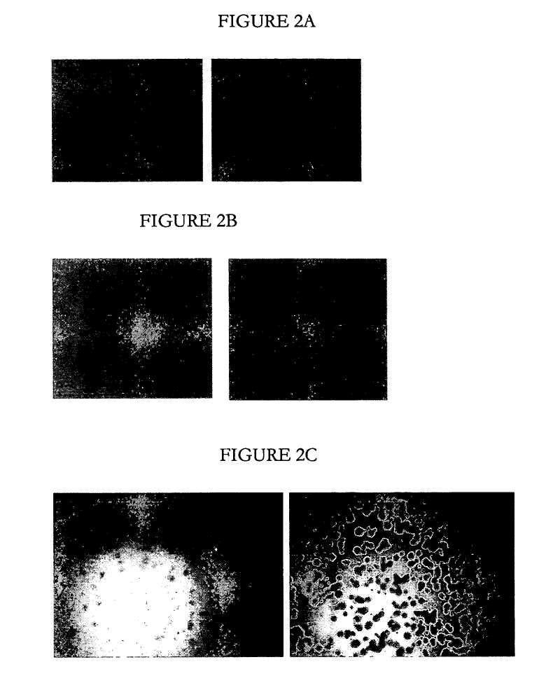

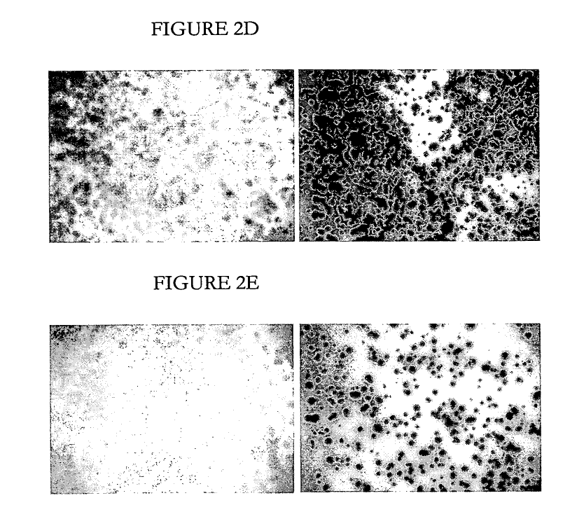

Living cells or biologically healthy cells have an integrated cell membrane, preventing entry of exogenous compounds such as dyes, or displaying entry selectivity against exogenous compounds. In contrast, damaged or dead cells have increased membrane permeability or no control of entry of exogenous compounds. Cell viability may be determined by staining the colonies grown on membrane filter with a dye or dye combination, or one or more than one dye. For example, using heat-killed cells (non-viable cells), the use of a dye or a dye combination provides unambiguous differentiation between living and dead cells (Example 1, FIG. 2). When staining with dye at appropriate concentration, and depending upon the dye or dye combination selected, the dead or damaged cells (colonies) may take up the dye and become colored within a short rime interval, for example within minutes, while the living cells actively exclude the dye and remain unstained (Example 1, FIG. 2). Furthermore, metabolically active cells (viable cells) can oxidize or reduce a variety of dyes to generate visually distinguishable morphology. For example, tetrazolium salts may be used for detecting redox potential of cells for viability. Following reduction, these water-soluble, colorless compounds form uncharged, brightly colored formazans in the cells. A combination of dyes may also be used to positively stain cells exhibiting decreased or no viability, and viable cells, if desired.

Several factors need to be considered in choosing a dye, dye combination, or one or more than one dye for the screening of cells of the present invention. Preferably, the dye or dye combination should provide sharp color difference between colored and uncolored colonies allowing unambiguous isolation of colored colonies. During staining, dye molecules travel through the membrane filter that supports the cell colonies, either by diffusion or capillary movement to contact the cells. The dye or dye combination should have no or a low affinity to the membrane filter so that the molecules can move up freely to contact the cells but not stain the filter significantly. The membrane is usually white in color, and provides a background contrasting reference for the stained colonies. Optimal concentration and staining time may be determined experimentally to achieve the best resolution for easy and unambiguous colony identification. The concentration of dye used is normally between about 0.001 to about 0.1% w/v or any amount therebetween, for example but not limited to, 0.001, 0.005, 0.01, 0.02, 0.03, 0.04, 0.05, 0.06, 0.07, 0.08, 0.09, and 0.1% w/v. Higher concentration of dye may result in increased staining of the membrane as well as the non-target cells, either living or dead as the case may be, leading to reduction in resolution. Staining time is from about 1 minutes to about 24 hour or any amount therebetween, preferably from about 1 minutes to about 1 hour or any amount therebetween, for example but not limited to 1, 2, 3, 5, 10, 15, 20, 25, 30, 35, 40, 45, 50, 55 and 60 minutes. Longer staining time may reduce throughput, but may be required to distinguish differences in cell viability. Further details in defining the staining protocols arm provided in the examples.

Numerous dyes exist that can be employed to stain the cell, providing they can unambiguously discriminate viable and non-viable cells by color difference. Preferably, the dye is selected from a vital dye, which may be used to stain dead cells. These include, but not limited to, trypan blue, bromothymol blue, oxonol, melanie, neutral red, methylene blue, indocyanine green, fluorogenic vital dyes 4′,6-diamidino-2-phenylindole (DAPI) and propidium iodide (PI), 7-AAD. Another group of dyes that may be used, stains viable cells, but not dead cells. Non-limiting examples of these dyes include Resazurin, tetrazolium salts, such as MTT. For the purpose of present invention, it is acceptable to use one or more than one dye that gives rise to a distinguishable color difference between viable and non-viable or damaged cells after a period of staining. Furthermore, different dyes can be used individually or as mixtures to detect viable and non-viable or reduced viability cells, and to maximize the identification of target colonies, for example nonviable or reduced viability colonies. The use of dye mixtures may allow simultaneous detection of various types of non-viable colonies, rising from different modes of action of expressed genes.

In the present invention, the host cells play dual functions. In one aspect, they are used to amplify the cloned genes arising from plasmid replication within the cells and cellular proliferation arising from cell division, and to synthesize transcribed and translated products of the cloned genes. In another aspect, they function as the target organism, against which the expression products exe their biocidal function. The biocidal activity is a result of an interaction between the molecules synthesized due to expression of the cloned genes and biological processes in host cells. As such, biocidal activity of a molecule may be host-specific. By choosing different host cells, biocidal molecules specific to different target species can be identified. For example, to identify antibacterial molecules, the preferred choice of the host cell will be a bacterial cell, such as but not limited to E. coli. To identify antifungal molecules, preferred choice of the host cell will be fungal cell, such as yeast. The present invention can be used to identify biocidal molecules against specific host cells, such as bacteria, fungi parasites, insects, tumors, or any other target organism of interest, providing that proper expression systems are available and the organism of interest can proliferate in vitro to form colony or colony-like structures. For example, the method is directly applicable to colony-forming pathogenic organisms, where expression vectors are available, such as Staphylococcus, Propionibacteria, Clostridium, Haemophilus, Candida albicans, Histoplasma capsulatum; Aspergillus nidulans. In addition to microbes, colony-forming cells form mammalian and insect sources can also be used for screening as described herein. Many cell lines particularly cancer cell lines, and insect cell lines can be cultured in vitro to form colonies, and are therefore of potential utility by the present invention to identify anti-cancer and anti-insect molecules, respectively.

For the purpose of present invention, any prokaryotic or eukaryotic cell that is capable of proliferating under suitable conditions can be employed as host cells. The hosts include, but not limited to, bacteria, fungi, microbes, insect cultured cells, mammalian cultured cells, and cells derived from cancer, carcinoma and tumor. Prokaryotic hosts are generally useful in isolating antimicrobial molecules that can be used to develop antibiotics or methods to control infectious disease in human, animal and plants. Eukaryotic hosts are useful in identifying genes whose products have potential for developing therapeutic agents or methods to control non-infectious disease and pests in plant, insect and human.

In a vast majority of cells hosting the expression library, compounds or molecules produced as a result of expression of the introduced DNA sequences may be non-toxic to the host cell. For example, using a grid-patching technique in which the E. coli clones are patched onto both rich repressing plates and minimal inducing plates, it was found that only 0.1% of the clones derived from a random oligonucleotide library contained inhibitory peptides. Similarly, despite large genome sizes, only a small number of sequences have been identified that encode antimicrobial proteins in each species. It is therefore advantageous to provide a method capable of screening large numbers of DNA sequences in a high throughput format and to identify biocidal DNA sequences that exist at low abundance.

To obtain a high throughput systems, cells transformed with a DNA library are grown on, or replicated onto, a membrane filer overlaying a solidified culture medium to form discrete colonies. This can be achieved by spreading the transformed cells onto membranes at appropriate density, or replicated onto the filter using a plate replica. Typically, a few thousand of colonies can be grown discretely on the surface of a membrane filter with a 100 mm diameter. Adhesion of cultured cells and their colonies to the membrane filter allows transfer of batches of colonies between different media, eliminating the need to transfer the colonies individually. This method can also prevent the cells from different colonies from mixing with each other.

To induce the expression of the cloned genes, the membrane filters bearing the colonies can be like off mom a non-inductive medium (i.e. medium lacking the inducer) and transferred to overlay on a medium containing an appropriate inducer, in addition to nutrients and selective agents. Alternatively, a replica of the colonies of the first membrane may be obtained using a second membrane and transferring the second membrane onto the media comprising the inducer. After induction, viability of cells and their colonies on the membrane filters can be assayed by transferring the filters, either the first membrane or second membrane depending upon which membrane was placed onto the inductive media, onto solidified dye solution for staining. Agar or other gelling agents commonly used in cell culture can be used to solidify the non-inductive, inductive, and staining media.

The advantages of using membrane filters include:
1) colonies can be grown on membranes at high density (up to hundreds of colonies per cm²) large number of colonies can be process to identify biocidal sequences that are even present at low frequency. For example, a library with 10⁶ colonies can be readily cultured on 1000 cm² membranes at density of 100 colonies/cm²;
2) colonies are formed, grown, induced, stained and examined on the same membrane, eliminating labor intensive, time consuming, and costly processes involving in individual colony pick up, transfer and assessment,
3) large number of colonies can be stained simultaneously on a membrane filter, further shortening the screening process;
4) colonies can be grown to a size easily visible to naked eye, therefore detection of stained colonies may not require sophisticated instrumentation; and
5) in situ detection of stained colonies, facilitates subsequent manipulations, such as stocking, purification, verification and DNA extraction.

The membrane filter must be biologically neutral to the host cell and permeable to all components used in culture. The membrane filter should also exhibit a low affinity to dye molecules so that it is not stained to a degree that masks out the stained colonies on it, and provides a contrast background for visualizing the stained cells and their colonies. Preferably the membrane is a porous, hydrophilic membrane, for example a cellulose, PVDF, nylon, paper, or nitrocellulose filter, available from Millipore Amersham, Corning, Boehringer Manheim, BioRad or GE.

After the step of staining, non-viable cell colonies can be identified by visual examination, by means of a stereo microscope, or by other image analysis tools, such as automatic colony counter and analyzer. Depending on the type of dye or dye combination used for staining, non-viable colonies will display a different color than that of viable cells (see FIGS. 2a-e). For example, after staining of E. coli colonies grown in standard LB medium with trypan blue, non-viable colonies will become dark-blue colored while viable colonies remain pale white (see FIG. 2a). Staining of the colonies with tetrazolium salts such as 2,3,5-triphenyl tetrazolium chloride turns viable colonies red, while non-viable colonies remain pale white.

Once the coloured (non-viable) colonies are identified, the cells, or corresponding cells growing on the non-induced media can be obtained from individual colonies using a sterile pipette toothpick, or needle, and processed further, for example, transferred to microtubes containing sterile distilled water or appropriate culture medium for subsequent manipulations, such as PCR, plasmid, amplification, growth inhibition assay, chemical analysis. For long-term storage, glycerol stock can be made by a method known to those skilled in the art.

Several approaches may be used to validate and analyze the biocidal activity, and identify the biocidal molecule, in an identified colony. One is to compare the growth of cells from, for example, one or more than one viable colony, with that of a non-viable or impaired colony under the same condition, preferably in a medium with the appropriate inducer. Reduction or loss or cell growth is a confirmation of the presence of biocidal molecules in the selected cells. Alternatively, a comparison of growth can be made by culturing the cells from the non-viable or impaired colonies in both inductive and non-inductive medium maintained under the same growth conditions. The reduction or loss of cell growth in inductive medium in comparison with non-inductive medium is an indication of synthesis of biocidal molecules in the cells.

The nucleic acid molecules can be amplified from the validated colonies using methods known in the art, such as but not limited to colony PCR. In colony PCR, the plasmid-containing cells are scraped from one single isolated colony using a pipette tip or autoclaved toothpick, and transferred to a PCR reaction tube directly for amplification without DNA purification. PCR primers can be designed according to the sequences flanking the inserts. For example, insert in commonly used commercial vector can be amplified by “universal primers”, such as T7 promoter primer, T3 promoter primer, M13 forward primer, and M13 reverse primer. Alternatively, the nucleic acid may be amplified by growing cells in an appropriate media, such as non-induced media, and isolating the target nucleic acid.

The sequence information can be used in several ways to further characterize the biocidal activity, and define the end compounds that cause the activity. In one aspect, the sequences can be compared to the DNA sequences stored in various databases. For example, the sequences can be searched against sequences in GenBank, EMBL, DDBJ, POD for possible homologues. The results are used to define further strategies in sequence characterization. A close homologue can lead to immediate validation of the cloned genes and variant genes. A failure to find highly homologous sequences may indicate discovery of new sequences.

In another aspect, the DNA sequences can be translated into amino acid sequences. Various bioinformatics tools al available for such translation, such as Lasergene manufactured by DNAStar, Inc (Madison, Mich.). The translated polypeptide or peptide sequences can be searched against relevant peptide sequence databases for homologues, as in case of DNA sequences. Furthermore, peptides consisting of up to 50 amino acids can be routinely synthesized chemically. The synthesized peptides can be used to conduct standard bioassays, such as agar diffusion assay, or a minimum inhibition concentration (MIC) assay, to validate its biocidal activity. Similarly, longer peptide or protein molecules can be produced by subcloning of the DNA sequence into appropriate expression vectors, and expressed and purified to use for the validation, in a similar manner as chemically synthesized peptides.

If the biocidal activity is not attributed to the protein or peptide that are directly coded by the DNA sequences fisher chemical or biochemical analysis can be used to identify the compound(s) that are directly responsible for the biocidal activity. This can be done by comparing the chemical compositions of cells expressing and not expressing the genes. Various chemical or biochemical tools are available for such analysis, such as HPLC and liquid chromatography/mass spectrometry (LC-MS), and metabolic profiling as would be known to one of skill in the art (e.g. Frenzel T., Miller A. Engel K. H., 2003, European Food Res. Technol. 216 (4): 335-342).

Molecules that are identified may then be assayed by conventional methods known in the art for the ability to kill or inhibit growth and replication of target cells or organism, both in vitro and in vivo. Such assays may include the steps of contacting or administering the test compounds with target cells or organism and measuring viability or proliferation of the target cells or organism. Any assays known in the art may be used, including those described in U.S. Pat. Nos. 5,858,974 and 4,411,990.

The biocidal molecules may be assayed on any organism or cell types of interest. They include but am not limited to: a) fungal species, for example Candida, Aspergillus, Cryptococcus, Histoplasma, Coccidioides, Paracoccidioides, Blastomyces, Basidiobolus, Conidiobolus, Rhizopus, Rhizomucor, Mucor, Absidia, Mortierella, Cunninghamella Saksenaea, Pseudallescheria, Sporotrichosis, Fusarium, Trichophyton, Trichosporon, Microsporum, Epidermophyton, Scytalidium, Malassezia, Actinomycetes, Sporothrix, Penicillium Saccharomyces and Pneumocystis, b) gram-negative bacterial species: for example Acidarinococcus, Acinetobacter, Aeromonas, Alcaligenes, Bacteroides, Bordetelia, Branhamella, Brucella, Calymmatobacterium, Campylobacter, Cardiobacterium, Chromobacterium, Citrobacter, Edwardsiella, Enterobacter, Escherichia, Flavobacterium, Francisella, Fusobacterium, Haemophilus, Klebsiella, Legionella, Moraxella, Morganella, Neisseria, Pasturella, Plesiomonas, Proteus, Providencia, Pseudomonas, Salmonella Serratia, Shigella, Streptobacillus, Veillonella, Vibrio, and Yersinia species; c) gram-positive bacterial species: for example Staphylococcus, Streptococcus, Micrococcus, Peptococcus, Peptostreptococcus, Enterococcus, Bacillus, Clostridium, Lactobacillus, Listeria, Erysipelothrix, Propionibacterium, Eubacterium, and Corynebacterium species; d) protozoa: for example Plasmodia, Taxoplasma, Leishmania, Trypanosoma, Acanihamoeba, Nagleria, and Pneumocystis species. species.

Insect species that may be tested include those of economically important to agriculture, animal and human health.

Other targets include isolated cell lines from animals, plants.

In the method of the present invention, there is no need of prior knowledge of the mechanism of be molecules against target organisms. Various approaches can be employed to study the mode of action of the biocidal molecules identified from the present invention. Such characterization would provide new insight into not only the mechanism of actions, but also applications of the identified molecules. In general, based on the modes of action of the biocidal molecules, they can be used in several ways, for example but not limited to:
1) the biocidal molecules or their derivatives can be used as active biocidal ingredients or in formulations;
2) the biocidal molecules can provide information for rational design of new molecules, and
3) the biocidal molecules may lead to identification of new targets for drug compound screening.

The use of biocidal compounds identified by the methods of the present invention can include the treatment of animals and plants exposed to undesired microbes. “Treatment” as used herein encompasses both prophylactic and therapeutic treatment.

The advantages of the method of the present invention include simplicity in the screening process, versatility in the surrogate host used, speed of screening, and low cost. The method also provides high efficiency screening of biocidal or AMP genes. The target nucleotide sequences to be identified by the screening process compose a very small portion of a genome. For example, to have a good coverage of cDNA in a library, the library would need to have 10⁵-10⁶ clones. To find for example, AMP genes in the library, a large number of clones need to be assayed for their effect on host cell viability. Cell viability has been done by transferring cells of each colony individually to assay media, such as wells of plates with culture medium, and measuring cell growth inhibition by various methods including optical density, or enzymatic assays. In contrast, the method of the present invention permits a large number of colonies to be grown, manipulated and stained. For example, a library consisting of 10⁶ clones can be grown on 100 membranes (dia. 100 mm), and be transferred to assay conditions in less than a hour and assayed for viability by colony coloration in hours. Furthermore, no specific or dedicated instrumentation is required to complete the screen of the present invention.

The present invention will be further illustrated in the following examples.

### EXAMPLE 1

### Colony Viability Staining Assay

One aspect of the present invention pertains to a quick and unambiguous detection of cells and heir colonies that have reduced or lost viability due to intracellular expression of gene in the recombinant vector.

Colony viability assays have been established as follows. E. coli cells were spread over a membrane filter such as Millipore MF membrane, and cultured at 37° C. over agar-solidified LB media for 20 hours, to form discrete colonies. A piece of the membrane (about 1×1 cm) bearing a number of the colonies is cut out. The cells on the membrane were killed by heating in a Petri dish floating in a water bath at 90° C. for 10 min. The membranes carrying the heat-treated colonies, alongside with membranes with untreated (not heated) colonies, were placed onto staining plates containing solutions of dye and dye combinations at different concentrations, solidified by 0.5% (w/v) agar. The dyes tested were bromophenol blue, trypan blue, oxonol and eosin Y. The concentrations of dye typically ranged from 0.1 to 0.001%. After few minutes, the coloration of the colonies on the membrane were evaluated by visual examination, and compared with one another to determine staining parameters for use in the screening, such as dye, concentration, and staining time.

As shown in FIG. 2, heat seated cells were highly stained after 5 to 10 minutes of staining with the appropriate dye, while living cells exhibited minor staining with the dyes tested, such as bromophenol blue, trypan blue, oxonol and eosin Y. The color differences can be further enhanced by using dye combinations, such as bromophenol blue, oxonol, try blue, and oxonol.

These results show that viability stains can be used to rapidly and readily distinguish viable and non-viable cells.

### EXAMPLE 2

### cDNA Library Construction in E. coli

A cDNA library was constructed from roots of seedlings of the rice cultivar “Kaybonnet”. Total RNA was extracted from 10 g of roots two weeks after germination by the guanidine thiocyanate/CsCl method. mRNA was separated from the total RNA extracted, using Oligo (dT)—Cellulose Columns (Invitrogen, Calif.). The yield of mRNA was about 1,2% based on the total RNA. cDNA synthesis from the mRNA was carried out using a commercial cDNA synthesis kit (Stratagene, Calif.). The cDNA synthesized was directionally inserted into Lambda ZAP® II Vector (Stratagene, Calif.), a lambda phage vector, pre-digested with EcoRI and Xho I, followed by infection of E. coli (strain XL 1-Blue MRP′) with the resulting recombinants, to generate a cDNA library. The titration of the library resulted in 1.8×10⁶ recombinant primary clones. The lambda phage vector was excised into phagemid vector following manufacture's instruction in E. coli SOLR cells (Stratagene. Calif.). These cells were used in screening experiments,

### EXAMPLE 3

### Oligo Library Construction in E. coli

A 115 bp Oligonucleotide:

(SEQ ID NO:4)

5′-AATACAGCATGCAT-(XXX)₂₀-TAATTAACCTCAGG-3′

was synthesized comprising a trityl group, and subsequently purified using an OPC cartridge. X denotes an equimolar mixture of the nucleotides A, C, G, or T. The sequences contain a start codon (ATG) in front of a random sequence portion, and a stop codon (TAA) 90 base pairs downstream from the start codon to provide termination signal. The complementary strand of the oligonucleotide was generated by a fill-in reaction with Klenow using an equimolar amount of the 14 oligonucleotide primer 5′-CCTGAGGTTAATTA-3′ (SEQ ID NO:5). Aft extension, the resulting ds-DNA was purified using a Promega DNA clean-up kit and restricted with Sph I and Bsu36 I. The digested DNA was again purified using a Promega DNA clean-up kit and ligated to the pET coco-2 vector (Novagen, Calif.) digested with the same two restriction enzymes. This plasmid has been developed to reduce basal expression by reducing copy number per cells to one to two in non-inductive (arabinose-free) condition. The inserted DNA sequence is under transcriptional control of a T7 promoter. 10 ng of the recombinant DNA was used to transform 20 μl of competent BL21(DE3) cell suspension by electroporation at 2.4 kv. The transformed cells were cultured in LB ampicillin (50 mg/L) agar medium to generate primary library. The titration of the library resulted in 9.8×10⁷ recombinant primary clones.

### EXAMPLE 4

### cDNA Library Construction in Yeast (pYES-Trp2)

A cDNA library was made from root of rice plants (cultivar “Kaybonnet”). RNA extraction and cDNA synthesis were made the same way as described in Example 2. The cDNA synthesized was directionally inserted into E. coli-Yeast shuttle vector pYES-Trp2 digested with EcoRI and XhoI I (Invitrogen). The recombinant DNA was used to transform TOP10F′ E. coli cells following the manufacturer's protocols. The library was then amplified by culturing in liquid LB medium with 100 mg/L ampicillin over night. Plasmid DNA was purified from the culture using a Qiagen plasmid DNA purification kit. The purified DNA was then transformed in to INVSc1 host yeast strain provided by Invitrogen according to the protocol provided by the manufacturer. The transformed cells were plated out on SC-U selective medium and cultured at 30° C. for 48 hours to generate primary yeast library. The library was scraped out of the agar plate and stored as glycerol stock according to manufacturer's instruction for subsequent use.

### EXAMPLE 5

### Screening Library in E. coli

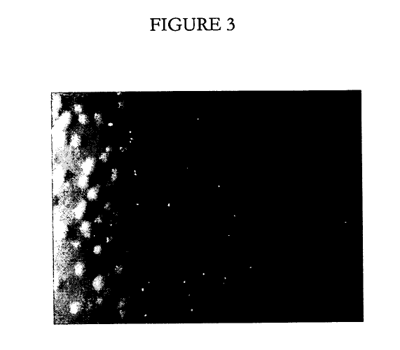

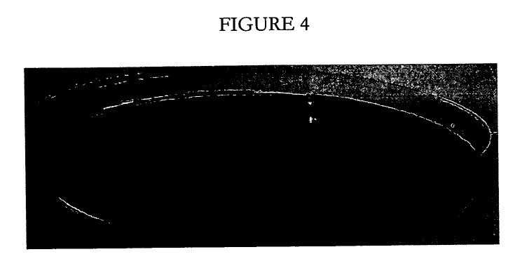

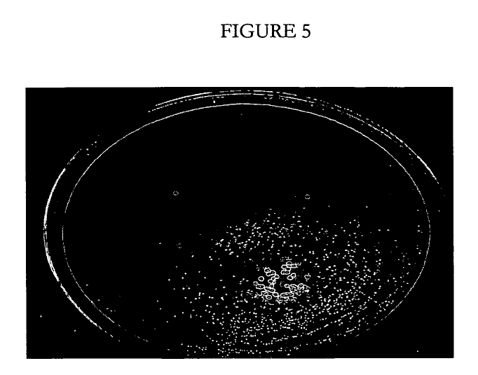

E. coli bacteria of the strain SOLR from frozen library stock prepared as described in Example 3 were plated out on MF medium filters (MF disc made with mixed cellulose esters with 0.8 μm pore size, Millipore, Mass.). Prior t to use, the MF membrane filters were autoclaved at 121° C. for 20 min, and then laid over 15 ml of solidified LB medium without inducer (IPTG) in Petri dishes. The culture density was pre-determined by culturing a series of dilutions of the same stock under the same condition and observations recorded on colony density. Typically, 100 μl of cell suspension was spread evenly over a 100 mm diameter membrane filter with a glass nod. The dishes were air-dried in a laminar flow hood for about 10 min and then incubated 37° C. in an incubator. Appropriate cell density was chosen to ensure formation of discrete colonies al overnight incubation (FIG. 3). After achieving a colony size of about 02-0.5 mm in diameter, the bacteria were transferred to induction medium containing 1 mM IPTG, by lifting the membrane filters from the initial plates and overlaying onto the LB agar medium with colony side facing up (e.g. FIG. 4). After the transfer, the bacteria were further cultured for another 1 to 6 hours in the presence of the inducer to induce gene expression. However, longer period of time may also be used to detect additional biocidal compounds. Expression of genes that are biocidal to the cells during the induction, periods impair cell growth or reduce cell viability in colonies where they are expressed. To determine the cells, colonies, or both cells and colonies with reduced or lost viability, the colonies on the filters were transferred to agar-solidified staining solution containing 0.05% of trypan blue (FIG. 4). The dye is taken up by dead cells or cells with reduced viability. This was done by lifting up the filters from induction medium and placing the filters to the staining plate with bacterial colonies facing up. After incubating the filter at room temperature for 10 to 20 minutes, the colonies on the filters were examined by eye or with aid of a stereo microscope for coloration. From 0 to 24 blue colored colonies were identified on each filter carrying 2000 to 4000 colonies (FIG. 5). Intensity of coloration as well as size of the colonies varied considerably. Strongly colored and small sized colonies may be indicative of “quick killing” highly biocidal molecules, synthesis inside these cells.

Following identification of selected cells or colonies, bacterial cells from the colored colonies were collected from individual colonies on the membrane filters, using a sterile needle or toothpick, and stored in liquid LB medium in 1.5 ml microtubes at 4° C. for immediate use, or made into glycerol stock for subsequent use. This method recovers any remaining viable cells within the colonies that exhibited reduced cell growth or cell death.

Alternative methods for plating and colony selection may also be employed. For example, following plating of the library on the medium that does not comprise the inducer on a first membrane, one or more than one replica-membrane (second membrane) may be lifted from the library comprising a portion of each of the cells or colonies, and transferred to either a medium that does not comprise the inducer to further grow the cells and colonies before negative selection on the medium containing inducer, or the replica membrane (second membrane) may be transferred onto the medium containing inducer. Following a period of time of exposure to the medium containing inducer, for example as described above, the cells or colonies on the second membrane are treated with a viability stain as described above to identify cells or colonies with reduced or no viability, and the corresponding cells or colony on the first membrane are obtained for further processing.

### EXAMPLE 6

### Screening Rice Library in Yeast

Yeast (Saccharomyces cerevisiae) cells of the strain INVSc1 (Invitrogen) containing recombinant plasmid pYES were plated out on MF medium filter as described in example 4. The filters were overlaid on SC-U agar medium solidified in Petri dishes and incubated at 30° C. The SC-U medium contains 2% glucose as carbon source. After the colonies grew to a size of 0.2-0.4 mm in diameter (20-30 hour), they were then transferred to induction SC-U medium containing 2% galactose, by lifting the membrane filter from the initial plates and overlaying onto the SC-U galactose agar plates with colony side facing up. In typical S. cerevisiae laboratory sums (i.e. INVSc1), transcription from the GAL1 promoter is repressed in the presence of glucose. Transcription may be induced by removing glucose and adding galactose as a carbon source. The cells were further cultured for 2 to 8 hours in the induction condition to induce gene expression. The filters with yeast colonies facing up was then transferred to agar (5 g/L)-solidified staining medium containing 0.05% trypan blue and stained for 10-25 minutes as room temperature. The filters were then examined for blue colored, impaired or unviable colonies as described in the previous example.

### EXAMPLE 7

### Screening Drosophila Library in Yeast

A cDNA library (Rfly2) was constructed from mRNA extracts of Drosophila melanogaster embryos in plasmid pRF4-60, under the control of the inducible promoter GAL1 (provided by R. Finley, Wayne State University, unpublished data).

The library was transformed into yeast (Saccharomyces cerevisiae by PEG/LiAc method and plated out on membranes (Millipore, Cat # HATF08250) laid out on synthetic dextrose (SD) agar plates without tryptophan for selection of transformed cells. The plates were incubated al 30° C. for 2-4 days until colonies were in size of 1-2 mm in diameter.

Once colonies appeared on the SD plates, each membrane was transferred to induction agar medium containing 2% of galactose (SG) for promoter induction and gene expression. The plates were incubated at 30° C. for six hours.

After incubation, membranes were lifted from the SG plates and placed on the staining agar containing 0.01% of trypan blue and 0.01% of bromophenol blue for five minutes. At this point the colonies were visually assessed for viability as colour change. In one screening, eight blue colonies were found and were picked from the membranes.

Plasmid DNA was extracted from these clones by standard method using commercial kit (QIAprep Spin Miniprep kit) and sequenced using the following primer, located upstream of the insertion site:

| | |
|---|---|
| VFly2-1 5′-TGATGTGCCAGATTATGC-3′ | (SEQ ID NO:6) |

The sequencing results were analysed using BLAST and other bioinformatics tool. Among the eight clones, three clones were shown to be empty vector. A possible explanation is that the biocidal genes cloned in the vector had been lost during the DNA amplification process, as cells carrying the biocidal gene are not biologically competitive with those that have lost the genes, due to deletion or other genetic recombination. Other clones were found to be identical or similar to D. melanogaster Tpi gene (two clones), D. melanogaster mitochondrial ATPase 8, D. melanogaster Ribosomal Protein S27A, and D. melanogaster 16s rRNA in antisense orientations The biocidal activity of these genes may be resulted from a number of mechanisms, such as cosuppression, complement inactivation and formation of inactivated chimeric proteins with endogenous yeast counterpart genes. For example, when expressed in yeast, the D. melanogaster mitochondrial ATPase 8 subunit and D. melanogaster Ribosomal Protein S27A may form a chimeric ATPase complex and ribosome with endogenous yeast ATPase subunits and ribosomal protein subunits (yeast ribosomal protein RPS3I), leading to loss or change of the protein function. This, in turn, implies that both ATPase and Ribosomal Protein S27A are essential proteins for yeast growth, and could therefore be potential drug screening targets.

### EXAMPLE 8

### Confirmation of Biocidal Activity Against E. coli

Bacteria from the selected colonies identified in Example 5 were resuspended in LB medium with 50 mg/L ampicillin. 10 μl aliquots of the suspension were inoculated to test tubes containing 5 ml of LB ampicillin medium with and without inducer (1 mM IPTG). After 14 hours of incubation at 37° C. on a shaker, the OD₆₀₀ values were measured with a spectrometer as an index of cell growth. In comparison with negative control (E. coli harboring the plasmid with no insert), bacteria from most of the selected colonies grew slower, and in some cases, the reduction even occurred in non-induction medium (Table 1).

TABLE 1
Inhibition of E. coli growth

OD₆₀₀

| Clone ID | Without IPTG | With IPTG |
|---|---|---|
| Control | 2.16 | 2.03 |
| (with plasmid only) | | |
| EBC1 | 0.22 | 0.01 |
| EBC2 | 0.33 | 0.00 |
| EBC3 | 0.56 | 0.02 |
| EBC4 | 1.22 | 1.45 |
| EBC5 | 0.45 | 0.22 |
| EBC6 | 0.78 | 0.23 |
| EBC7 | 2.12 | 1.98 |
| EBC8 | 0.99 | 0.00 |
| EBC9 | 1.78 | 1.55 |
| EBC10 | 2.01 | 0.11 |
| EBC11 | 1.99 | 0.72 |

Increased plasmid size as result of insertions in the recombinant plasmids as well as leaking or basal expression of the inserted gene may be responsible for the growth reduction for the E. coli cells in non-induction medium. Furthermore, various degrees of cell growth inhibitions were seen, particularly in clone EBC1, EBC2, EBC3, and EBC8, where virtually no proliferation of bacterial cells was detected after 14 hour cultivation, indicating that the viability staining was effective in detecting non-viable or less viable cells/colonies under the present context. Bacteria in three of the colonies tested (EBC4, EBC7, EBC9), however, did not show inducer-dependent growth reduction. Therefore, induced expression of the genes in these colonies likely resulted in increased cell membrane permeability or increased affinity to staining dye trypan blue, but had no significant impact on biological function of the cells. These colonies were not characterized any further.

### EXAMPLE 9

### Sequencing of Putative Biocidal DINA Molecules

Colony PCR was performed on the selected colonies as a quick method to obtain sequence information. Small amount of cells were obtained from the colonies and used for PCR reaction directly. Primers used were:

| | |
|---|---|
| T7 promotor primer: | |
| 5′-TAA TAC GAC TCA CTA TAG G-3′; | (SEQ ID NO:7) |
| T3 terminator primer: | |
| 5′-GCT AGT TAT TGC TCA GCG G-3′; | (SEQ ID NO:8) |
| M13 Reverse primer: | |
| 5′-CAG GAA ACA GCT ATG ACC-3′; | (SEQ ID NO:9) |
| and | |
| M13 Forward primer: | |
| 5′-TGT AAA ACG ACG GCC AGT-3′. | (SEQ ID NO:10) |

insert DNA from over 90% colonies were successfully amplified. The insert sequences were determined from both sides of the sequences on an Applied Biosystems 377 Prism DNA Sequencer. For DNA longer than 1 kb, internal sequencing primers were designed to complete the full sequencing of the whole inserts.

### EXAMPLE 10

### Analysis of DNA Sequences

10 Putative biocidal DNA sequences isolated from rice root library were BLAST-researched against existing databases, available from NCBI (the National Center for Biotechnology Information; see http://www.ncbi.nlm.nih.gov/BLAST/). The results are summarized as follows:
1. R1-3 is a 584 bp clone, with 99% sequence similarity to a rice germin-like protein 16 cDNA clone: 001-108-B05 (Genbank ACCESSION number AK062862)and 78% sequence similarity to Triticum aestivum mRNA for germin-like protein 2a (Genbank ACCESSION number AJ237942). Germins and germin-like proteins widely exist in cereals and play important roles in plant defense against pathogens. Wheat germin was recently identified as functional oxalate oxidase (OXOX; E.C. 1.2.3.4). OXOX converts oxalate into CO₂ and H₂O₂, the latter is a well known microcidal agent. One of the oxalate oxidases has recently been described in U.S. Pat. No. 6,235,530 for its use to increase plant resistance to infection by Sclerorinia sclerotiorum.
2. R4-11 is a 1170 bp clone, exhibits sequence identity with a number of rice putative peroxidase clones, and is 95% similar to the putative peroxidase mRNA (gi|34902229|ref|NM_{—}187572.1|), as well as a number of uncharacterized rice cDNA clones in the databases. Peroxidase enzymes can kill bacteria by oxidative mechanisms. In rice, expression of peroxidase gene has been shown to be up-regulated by pathogen (Magnaporthe grisea) attack, indicating their involvement in plant defense systems. Peroxidase has also been demonstrated to have antifungal activity.
3. R4-3 is highly similar to thaumatin-like protein (gi|20375|emb|X68197.1|OSTHLP). Thaumatin and thaumatin-like proteins are well studied antimicrobial proteins, existing widely in plant species. For example, zeamatin from maize is active against a range of fungi (Candida albicans (C. P. Robin) Berkhout, Neurospora crassa Shear and Dodge, T. reesei, F. oxysporum, and Alternaria solani Sorauer). They may act by permeabilization of the hyphal membrane, leading to leakage and rupture. Hence the name permearins has been proposed for zeamatin and related AFPs from barley, oat, wheat, sorghum, and flax (Linum usitatissimum L)
4. R1-4 is homologous to rice seed storage protein prolamin, which also express in a number of tissues. Rice prolamin belongs to cereal prolamin family. The protein is also considered to have defense function against infections.
5. R4-9 is similar to Syntaxin

6. R4-10, R4-5, R1-31 are clones without known sequence homology in the database.

All citations are hereby incorporated by reference.

The present invention has been described with regard to one or more embodiments. However, it will be apparent to persons skilled in the art that a number of variations and modifications can be made without departing from the scope of the invention as defined in the claims.

What is claimed is:

1. A method of identifying nucleic acid sequence encoding molecule having biocidal function comprising the steps of:
a. constructing a library of nucleic acid molecules, isolated from an organism or part thereof, or synthesized chemically, each of the nucleic acid molecules operably linked to an inducible promoter sequence in a vector,
b. inducing the library into host cells to produce transformed cells;
c. growing the transformed cells in the absence of an inducer,
d. adding the inducer and growing the transformed cells to express each of the nucleic acid molecules in the library to produce a library of induced colonies or cells;
e. staining the induced colonies or cells with one or more than one dye;
f. determining the viability of the induced colonies or cells, and identifying colonies with reduced or lost cell viability; and
g. isolating the nucleic acid sequence from the colonies or cells with reduced or lost cell viability.

2. The method of claim 1, wherein in the step of staining (step e.) the one or more than one dye is selected from the group consisting of a dye that stains a viable cell, a dye that stains a non-viable cell, and a dye that stains a cell with reduced viability.

3. The method of claim 2, wherein the one or more than one dye is select from the group consisting of trypan blue, bromothymol blue, oxonol, melanie neutral red, methylene blue, indocyanine green, a fluorogenic vital dye, 4′,6-diamidino-2-phenylindole (DAPI), propidium iodide (PI), 7-AAD, Resazurin, a tetrazolium salt and MTT.

4. The method of claim 1, wherein in the step of adding (step d.) replica sets of transformed cells are obtained from the transformed cells, one replica of the replica set is grown in the absence of the inducer, and a second replica of the replica set is grown in the presence of the inducer to produce induced colonies or cells.

5. The method of claim 1 wherein the host cells are prokaryotic cells.

6. The method of claim 1 wherein the host cells are eukaryotic cells.

7. The method of claim 1 wherein the host cells are bacterial cells selected from the group consisting of Acidaminococcus, Acinetobacter, Aeromonas, Alcaligenes, Bacteroides, Bordetella, Branhamella, Brucella, Calymmatobacterium, Campylobacter, Cardiobacterium, Chromobacterium, Citrobacter, Edwardsiella, Enterobacter, Escherichia, Flavobacterium, Francisella, Fusobacterium, Haemophilus, Klebsiella, Legionella, Moraxella, Morganella, Neisseria, Pasturella, Plesiomonas, Proteus, Providencia, Pseudomonas, Salmonella, Serratia, Shigella, Staphylococcus, Streptobacillus, Veillonella, Vibrio, and Yersinia.

8. The method of claim 1 wherein the host cells are fungal cells selected from the group consisting of Candida, Aspergillus, Cryptococcus, Histoplasma, Coccidioides, Paracoccidioides, Blastomyces, Basidiobolus, Conidiobolus, Rhizopus, Rhizomucor, Mucor, Absidia, Mortierella, Cunninghamella, Saksenaea, Pseudallescheria, Sporotrichosis, Fusarium, Trichophyton, Trichosporon, Microsporum, Epidermophyton, Scytalidium, Malassezia, Actinomycetes, Sporothrix, Penicillium, Saccharomyces and Pneumocystis.

9. The method of claim 1 wherein host cells are eukaryotic cells isolated from a plant.

10. The method of claim 1 wherein the host cells are eukaryotic cells isolated from an animal.

11. The method of claim 1 wherein, in the step of growing (step c.), the step of adding (step d.), the step of staining (step e.), or a combination thereof, the transformed host cells are cultured on a solid support.

12. The method of claim 11 wherein the solid support is a membrane filter, selected from the group consisting of cellulose, nitrocellulose, nylon, and PVDF membranes.

13. The method of claim 1 wherein in the step of constructing (step a.) the inducible promoter is a transcriptional regulating sequence controlled by a chemical agent

14. The method of claim 13 wherein the chemical agent is isopropyl thiogalactoside (IPTG).

15. The method of claim 13 wherein the chemical agent is galactose.
